(19) United States
(12) Patent Application Publication
(10) Pub. No.: US 2021/0204366 A1
(43) Pub. Date: Jul. 1, 2021

(54) PANE HAVING HEATABLE TCO COATING

(71) Applicant: SAINT-GOBAIN GLASS FRANCE, COURBEVOIE (FR)

(72) Inventors: Jan HAGEN, Bonn (DE); Dagmar SCHAEFER, Herzogenrath (DE); Florent CREUTIN, Aachen (DE)

(21) Appl. No.: 16/606,059

(22) PCT Filed: Mar. 19, 2018
(86) PCT No.: PCT/EP2018/056796

§ 371 Date: Oct. 17, 2019

(30) Foreign Application Priority Data
Apr. 18, 2017 (EP) 17166844.5

(51) Int. Cl. H05B 3/86; G02B 1/11; H05B 3/14; H05B 3/28; C03C 17/34

(52) U.S. Cl. CPC H05B 3/86; G02B 1/11; H05B 3/141; H05B 3/283; C03C 17/3435; C03C 2218/156; H05B 2203/013; H05B 2203/017; C03C 2217/213; C03C 2217/24; C03C 2217/281; C03C 17/3441

(57) ABSTRACT

A pane having a heatable coating, includes a substrate and a heatable coating on an exposed surface of the substrate, which heatable coating at least includes an electrically conductive layer, which contains a transparent, electrically conductive oxide (TCO) and has a thickness of 1 nm to 40 nm, and above the electrically conductive layer, a dielectric barrier layer for regulating oxygen diffusion, which dielectric barrier layer contains a metal, a nitride, or a carbide and has a thickness of 1 nm to 20 nm, wherein the pane has transmittance in the visible spectral range of at least 70% and the coating has sheet resistance of 50 ohms/square to 200 ohms/square.

The invention relates to a pane having a heatable coating, as well as production and use thereof.

Glass panes that can be heated by means of substantially transparent coatings are known per se. Often, the heatable coating contains an electrically conductive silver layer, on which the heating effect is based, as well as further, dielectric layers, for example, antireflection layers, blocking layers, or barrier layers. The disadvantage of silver-containing coatings is their high susceptibility to corrosion, as a result of which the coatings can only be used on sealed surfaces of the glass pane that have no contact with the surrounding atmosphere. Thus, silver-containing coatings can be used, for example, on the inner surfaces of laminated glass or insulating glazing units.

Also known as a less corrosion-susceptible alternative are heatable coatings based on transparent conductive oxides (TCOs). These can even be used on the exposed surfaces of the glass panes exposed to the atmosphere. Due to the lower conductivity of TCOs compared to silver, the view was long held that the TCO layers had to be relatively thick in order to obtain suitable heat output. However, the production costs of glass panes are drastically increased as a result. Heatable coatings based on TCOs are known, for example, from WO2012168628A1, WO2007018951A1, U.S. Pat. No. 5,852,284A, and US2004214010A1.

WO2015091016 discloses a vehicle pane having an electrically heatable coating. The coating preferably contains silver layers; however, transparent conductive oxides are also mentioned as an alternative. The pane is preferably a windshield, i.e., a composite pane, wherein the heatable coating is arranged on an inner surface, where it is protected from the surrounding atmosphere.

WO2007018951A1 discloses a pane with a TCO coating. Arranged above the TCO layer is a barrier layer made of silicon nitride, which is intended to protect the TCO layer against oxidation during a tempering process. A suitable or necessary thickness of the barrier layer is not disclosed.

The object of the present invention consists in providing an improved pane having a heatable coating that can be used on the exposed surfaces of the glass pane and is economical to produce.

The object of the present invention is accomplished according to the invention by a pane having a heatable coating according to claim 1. Preferred embodiments are apparent from the dependent claims.

The pane according to the invention having a heatable coating comprises a substrate and a heatable coating on a surface of the substrate. The heatable coating includes at least one electrically conductive layer and, above the electrically conductive layer, a dielectric barrier layer for regulating oxygen diffusion.

The pane according to the invention is preferably provided as a window pane, in particular a building window pane, as a refrigerator door, as an oven door, as a partition, or as a bathroom mirror. Due to the heating effect, the pane can result in heating of the physical surroundings and it can be freed of condensation or icing, creating a particularly beneficial effect in these applications. The coating according to the invention is distinguished in particular by the very thin conductive TCO layer. The inventors have surprisingly discovered that an adequate heating effect can be obtained therewith even with the use of customary supply voltages. The production costs are significantly reduced by the low material usage. This is a major advantage of the present invention.

The pane according to the invention has transmittance in the visible spectral range of at least 70%. The term “visible spectral range” means the spectral range from 400 nm to 750 nm. the transmittance is preferably determined per the standard DIN EN 410. The coating has sheet resistance of 50 ohms/square to 200 ohms/square, preferably of 50 ohms/square to 100 ohms/square. Such a sheet resistance can be obtained with the thin TCO layers according to the invention and results in suitable heat output with customary operating voltages.

The substrate is made of a transparent, electrically insulating, in particular a rigid material, preferably of glass or plastic. The substrate contains, in a preferred embodiment, soda lime glass but can however, in principle, also contain other types of glass, for example, borosilicate glass or quartz glass. The substrate contains, in another preferred embodiment, polycarbonate (PC) or polymethyl methacrylate (PMMA). The substrate preferably has a thickness of 1 mm to 20 mm, typically from 2 mm to 5 mm. The substrate can be planar or even bent. In a particularly advantageous embodiment, the substrate is a thermally prestressed glass pane.

The coating can be arranged on an exposed surface of the substrate. This means a surface that is accessible and has direct contact with the surrounding atmosphere. The coating is adequately corrosion resistant for this. The coating can, however, also be applied on a nonexposed surface, for example, on one of the non-accessible, inner surfaces of a composite glass or insulating glass. This can be advantageous for preventing individuals from making contact with the coating, which could result in an electric shock, depending on the operating voltage.

Application of the coating on an exposed surface of the substrate is preferred since the advantage of the coating according to the invention is its corrosion resistance, without which such a use is impossible. Thus, new applications for heatable coatings are provided. The exposed surface is accessible in the installation position, can thus, for example, be touched and has direct contact with the surrounding atmosphere. When the pane according to the invention is part of a pane assembly that includes at least one other pane in addition to the pane according to the invention, such as a composite pane or an insulating glazing unit, the exposed surface of the pane according to the invention faces away from all the other panes of the pane assembly. In composite panes, the pane according to the invention is laminated with one or a plurality of other panes via a thermoplastic intermediate layer in each case. In insulating glazing units, the pane according to the invention is joined to one or a plurality of other panes in each case via a peripheral, circumferential spacer such that a gas filled or evacuated intermediate space is produced in each case between the panes. In the case of a composite pane, the exposed surface thus does not face the thermoplastic intermediate layer and the other pane, but, instead, faces away from them. In the case of an insulating glazing unit, the exposed surface thus does not face the intermediate space and the other pane, but, instead, faces away from them. When the pane assembly includes more than two panes, obviously, the pane according to the invention must be an outside pane because only these have an exposed surface.

When a first layer is arranged above a second layer, this means, in the context of the invention, that the first layer is arranged farther from the substrate than the second layer is. When a first layer is arranged below a second layer, this means, in the context of the invention, that the second layer is arranged farther from the substrate than the first layer is. If a first layer is arranged above or below a second layer, this does not necessarily mean, in the context of the invention, that the first and the second layer are situated in direct contact with one another. One or more additional layers can be arranged between the first and the second layer, unless this is explicitly ruled out.

The coating is typically applied over the entire surface of the substrate, possibly with the exception of a circumferential edge region and/or another locally limited region that can serve, for example, for data transmission. The coating can also be patterned by coating-free lines through which the current flow can be suitably directed. The coated portion of the substrate surface preferably amounts to at least 90%.

When a layer or another element contains at least one material, this includes, in the context of the invention, the case in which the layer is made of the material, which is, in principle, also preferable. The compounds described in the context of the present invention, in particular oxides, nitrides, and carbides, can, in principle, be stoichiometric, substoichiometric, or superstoichiometric, even if the stoichiometric molecular formulas are cited for the sake of better understanding.

The values indicated for refractive indices are measured at a wavelength of 550 nm.

The electrically conductive layer contains, according to the invention, at least one transparent, electrically conductive oxide (TCO) and has a thickness of 1 nm to 40 nm, preferably of 10 nm to 35 nm. Even with these low thicknesses, an adequate heating effect can be obtained with suitable voltage. The conductive layer preferably contains indium tin oxide (ITO), which has proved especially useful, in particular due to low specific resistance and low scattering with regard to the sheet resistance. As a result, a very uniform heating effect is ensured. However, alternatively, the conductive layer can also contain, for example, mixed indium zinc oxide (IZO), gallium-doped tin oxide (GZO), fluorine-doped tin oxide (SnO₂:F), or antimony-doped tin oxide (SnO₂:Sb). The refractive index of the transparent, electrically conductive oxide is preferably from 1.7 to 2.3.

It has been found that the oxygen content of the electrically conductive layer has a substantial influence on its properties, in particular transparency and conductivity. The production of the pane typically includes a temperature treatment wherein oxygen can diffuse to the conductive layer and can oxidize it. The dielectric barrier layer according to the invention for regulating oxygen diffusion serves to adjust the oxygen transfer to an optimum level.

The dielectric barrier layer for regulating oxygen diffusion contains at least one metal, a nitride, or a carbide. The barrier layer can, for example, contain titanium, chromium, nickel, zirconium, hafnium, niobium, tantalum, or tungsten or a nitride or carbide of tungsten, niobium, tantalum, zirconium, hafnium, chromium, titanium, silicon, or aluminum. In a preferred embodiment, the barrier layer contains silicon nitride (Si₃N₄) or silicon carbide, in particular silicon nitride (Si₃N₄), with which particularly good results are obtained. The silicon nitride can be doped, and in a preferred development, is doped with aluminum (Si₃N₄:Al), with zirconium (Si₃N₄:Zr), or with boron (Si₃N₄:B). In a temperature treatment after application of the coating according to the invention, the silicon nitride can be partially oxidized. A barrier layer deposited as Si₃N₄ then contains SiₓN_{Y}O_{z}, after the temperature treatment, wherein the oxygen content is typically from 0 atomic percent to 35 atomic percent.

The thickness of the barrier layer is preferably from 1 nm to 20 nm. In this range, particularly good results are obtained. If the barrier layer is thinner, it has too little or no effect. If the barrier layer is thicker, it can then be problematic to electrically contact the underlying conductive layer, for example, by means of a busbar applied on the barrier layer. The thickness of the barrier layer is particularly preferably from 2 nm to 10 nm. With this, the oxygen content of the conductive layer is regulated particularly advantageously.

In an advantageous embodiment, the heatable coating according to the invention contains an optical matching layer below the electrically conductive layer. It preferably has a layer thickness from 5 nm to 50 nm, particularly preferably from 5 nm to 30 nm.

In an advantageous embodiment, the heatable coating according to the invention contains an antireflection layer above the electrically conductive layer. It preferably has a layer thickness of 10 nm to 100 nm, particularly preferably of 15 nm to 50 nm.

The optical matching layer and the antireflection layer bring about, in particular, advantageous optical properties of the pane. Thus, they reduce the degree of reflection and thereby increase the transparency of the pane and ensure a neutral color impression. The optical matching layer and/or the antireflection layer have a lower refractive index than the electrically conductive layer, preferably a refractive index of 1.3 to 1.8. The optical matching layer and/or the antireflection layer preferably contain an oxide, particularly preferably silicon oxide. The silicon oxide can be doped and is preferably doped with aluminum (SiO₂:Al), with boron (SiO₂:B), or with zirconium (SiO₂:Zr). However, alternatively, the layers can also contain, for example, aluminum oxide (Al₂O₃).

In a particularly advantageous embodiment, the coating includes, below the electrically conductive layer, and optionally below the optical matching layer, a blocking layer against alkali diffusion. The blocking layer reduces or prevents the diffusion of alkali ions out of the glass substrate into the layer system. Alkali ions can negatively impact the properties of the coating. The blocking layer preferably contains a nitride or a carbide, for example, of tungsten, niobium, tantalum, zirconium, hafnium, titanium, silicon, or aluminum, particularly preferably silicon nitride (Si₃N₄), with which particularly good results are obtained. The silicon nitride can be doped and in a preferred development, is doped with aluminum (Si₃N₄:Al), with zirconium (Si₃N₄:Zr), or with boron (Si₃N₄:B). The thickness of the blocking layer is preferably from 5 nm to 50 nm, particularly preferably from 5 nm to 30 nm.

In an advantageous embodiment, the coating is provided with busbars that can be connected to the poles of a voltage source in order to introduce current into the coating over the entire pane width or at least a large part of the pane width. The busbars are preferably implemented as printed and fired conductors that contain at least one metal, preferably silver. The electrical conductivity is preferably realized by means of metal particles contained in the busbars, particularly preferably via silver particles. The metal particles can be situated in an organic and/or inorganic matrix such as pastes or inks, preferably as a fired screen printing paste with glass frits. The layer thickness of the printed busbars is preferably from 5 μm to 40 μm, particularly preferably from 10 μm to 20 μm. Printed busbars with these thicknesses are technically simple to realize and have an advantageous current carrying capability. In an alternative preferred embodiment, the busbars are implemented as strips of an electrically conductive foil, in particular of a metal foil, for example, copper foil or aluminum foil. The foil strips can be laid or adhesively bonded. The thickness of the foil is preferably from 30 μm to 200 μm.

The voltage source to which the pane is intended to be connected preferably has a voltage from 40 V to 250 V. When the pane is operated with these voltages, good heat outputs are obtained, with which the pane can be quickly freed of condensation and ice. In a first preferred embodiment, the voltage is from 210 V to 250 V, for example, 220 V to 230 V. The pane can then be operated with the standard network voltage, which is particularly suitable for a heat output with which the pane can be quickly freed of condensation or icing. In a second preferred embodiment, the voltage is from 40 V to 55 V, for example, 48 V. Such voltages are noncritical in the event of direct contact by a person such that the coating can be arranged on an exposed surface. The lower operating voltage is accompanied by a lower heat output which can, however, be adequate depending on the application, for example, to prevent a so-called “cold wall effect” (heat sink) of a window or of an interior partition. In one embodiment of the invention, the pane is connected to a voltage source of 40 V to 250 V, in particular of 40 V to 55 V or of 210 V to 250 V.

In a preferred embodiment, the coating consists only of the layers described and contains no other layers.

In a particularly preferred embodiment, the pane according to the invention is part of an insulating glazing unit. The invention also includes such an insulating glazing unit comprising the pane according to the invention and at least one other pane. The other pane need not be implemented in accordance with the invention, thus need have no heatable coating on its exposed surface. The pane according to the invention and the at least one additional pane are joined via a peripheral, preferably circumferential spacer such that an intermediate space that can be gas-filled or evacuated is formed between the panes.

The invention also includes a method for producing a pane having a heatable coating, wherein

(a) successively applied on a surface of a substrate are at least the following
an electrically conductive layer that contains a transparent, electrically conductive oxide and has a thickness of 1 nm to 40 nm and
a dielectric barrier layer for regulating oxygen diffusion that contains at least a metal, a nitride, or a carbide;

(b) the substrate having the coating is subjected to a temperature treatment at at least 100° C., after which the pane has transmittance in the visible spectral range of at least 70% and the coating has sheet resistance of 50 ohms/square to 200 ohms/square.

After the application of the heatable coating, the pane is preferably subjected to a temperature treatment by means of which, in particular, the crystallinity of the functional layer is improved. The temperature treatment is preferably done at at least 300° C. The temperature treatment reduces, in particular, the sheet resistance of the coating. In addition, the optical properties of the pane are significantly improved.

The temperature treatment can be done in various ways, for example, by heating the pane using a furnace or a radiant heater. Alternatively, the temperature treatment can also be done by irradiation with light, for example, with a lamp or a laser as a light source.

In an advantageous embodiment, the temperature treatment is done in the case of a glass substrate within a thermal prestressing operation. Here, the heated substrate is impinged on by an air flow, being rapidly cooled thereby. Compressive stresses are formed on the surface of the pane; tensile stresses, in the core of the pane. The characteristic stress distribution increases the breaking resistance of the glass panes. A bending process can also precede the prestressing.

Before or after the application of the heatable coating, busbars are installed, preferably printed, particularly preferably using screen printing as a silver-containing printing paste with glass frits, or laid or adhesively bonded as strips of a conductive foil. Printing of the busbars is preferably done before the temperature treatment such that the firing of the printing paste can be done during the temperature treatment and need not be carried out as a separate step.

The individual layers of the heatable coating are deposited by methods known per se, preferably by magnetron-enhanced cathodic sputtering. This is particularly advantageous in terms of a simple, quick, economical, and uniform coating of the substrate. The cathodic sputtering is done in a protective gas atmosphere, for example, of argon, or in a reactive gas atmosphere, for example, by addition of oxygen or nitrogen. The layers can, however, also be applied using other methods known to the person skilled in the art, for example, by vapor deposition or chemical vapour deposition (CVD), by atomic layer deposition (ALD), by plasma-enhanced chemical vapor deposition (PECVD), or using wet chemical methods.

In an advantageous embodiment, a blocking layer against alkali diffusion is applied before the electrically conductive layer. In an advantageous embodiment, an optical matching layer is applied before the electrically conductive layer and, optionally, after the blocking layer. An antireflection layer is applied after the barrier layer in an advantageous embodiment.

The invention also includes the use of a pane according to the invention having an operating voltage of 40 V to 250 V, preferably as a refrigerator door, oven door, partition, bathroom mirror, or window or as a component thereof. The operating voltage is preferably from 40 V to 55V, for example, approx. 48 V, or from 210 V to 250 V, for example, approx. 220 V or 230 V. The pane according to the invention is particularly preferably used as part of an insulating glazing unit, wherein it is joined with at least one other pane via a peripheral, preferably circumferential spacer such that an intermediate space that can be gas-filled or evacuated is formed between the panes. Here, the other pane need not be configured according to the invention.

In the following, the invention is explained in detail with reference to drawings and exemplary embodiments. The drawings are a schematic representation and are not true to scale. The drawings in no way restrict the invention.

They depict:

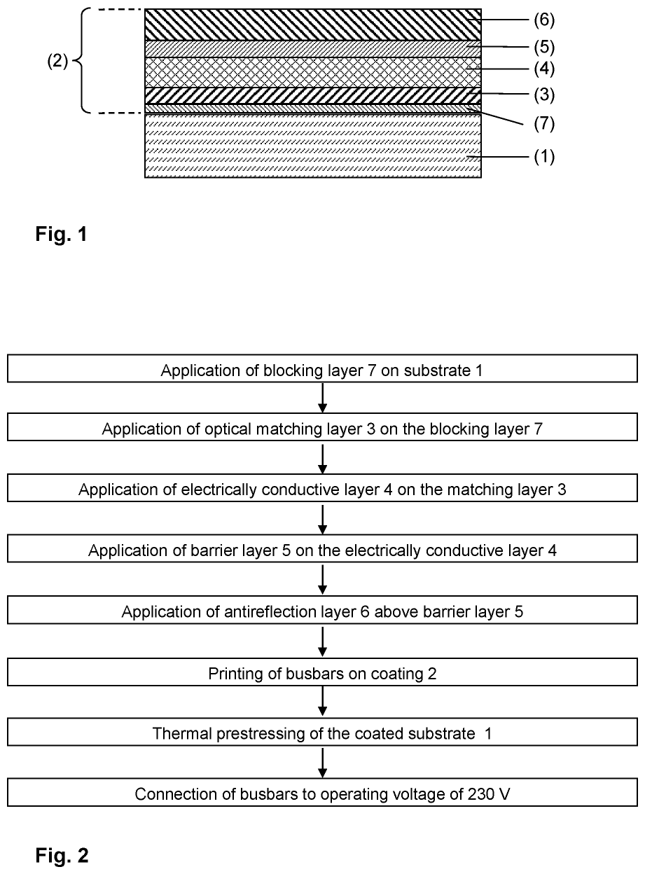

FIG. 1 a cross-section through an embodiment of the pane according to the invention having a heatable coating,

FIG. 2 a flowchart of an embodiment of the method according to the invention.

FIG. 1 depicts a cross-section through an embodiment of the pane according to the invention with the substrate 1 and the heatable coating 2. The substrate 1 is, for example, a glass pane made of soda lime glass and has a thickness of 4 mm. The pane is, for example, a component of a refrigerator door. The coating is applied on the refrigerator-side surface of the pane. When the coating is heated, condensation on the outer surface of the refrigerator door as well as condensation and icing on the refrigerator-side surface can be removed. The pane can be a component of an insulating glazing unit, in particular the outer pane of an insulating glazing unit such that the coating 2 is arranged protected in the interior of the glazing unit.

The coating 2 comprises, starting from the substrate 1, a blocking layer 7 against alkali diffusion, an optical matching layer 3, an electrically conductive layer 4, a barrier layer 5 for regulating the oxygen diffusion layer 5, and an antireflection layer 6. The materials and the layer thicknesses are summarized in Table 1. The individual layers of the coating 2 were deposited by magnetron-enhanced cathodic sputtering.

TABLE 1

| Layer | Reference No. | | Material | Thickness |
|---|---|---|---|---|
| Antireflection layer | 6 | 2 | SiO₂:Al | 20 nm |
| Barrier layer | 5 | | Si₃N₄:Al | 10 nm |
| Electrically conductive layer | 4 | | ITO | 22 nm |
| Optical matching layer | 3 | | SiO₂:Al | 11 nm |
| Blocking layer | 7 | | Si₃N₄:Al | 5 nm |

| | | | |
|---|---|---|---|
| Substrate | 1 | Glass | 4 mm |

Despite the low thickness of the conductive layer 4, it was possible to obtain a good heating effect with the coating 2, connected to a voltage source of 230 V. The coating 2 also proved to be corrosion resistant and stable over the long-term on the exposed refrigerator-side surface of the substrate 1.

FIG. 2 depicts a flowchart of an exemplary embodiment of the production method according to the invention.

### EXAMPLES

Various coatings 2 were produced and investigated. The materials and layer thicknesses of the Examples 1 to 3 are presented in Table 2. The transmittance T_{L} and reflectivity R_{L} in the visible spectral range as well as the sheet resistance R_{sq} are summarized in Table 3.

TABLE 2

| | | | Thickness | | |
|---|---|---|---|---|---|
| Reference No. | | Material | Example 1 | Example 2 | Example 3 |
| 2 | 6 | SiO₂:Al | 20 nm | 25 nm | 38 nm |
| | 5 | Si₃N₄:Al | 10 nm | 10 nm | 10 nm |
| | 4 | ITO | 22 nm | 27 nm | 32 nm |
| | 3 | SiO₂:Al | 11 nm | 11 nm | 11 nm |
| | 7 | Si₃N₄:Al | 5 nm | 5 nm | 5 nm |

| | | | | |
|---|---|---|---|---|
| 1 | Glass | 4 mm | 4 mm | 4 mm |

TABLE 3

| | T_{L}/% | R_{L}/% | R_{sq}/Ohm |
|---|---|---|---|
| Example 1 | 83.9 | 13.2 | 81 |
| Example 2 | 83.4 | 13.8 | 63 |
| Example 3 | 83.7 | 13.5 | 55 |

The coatings of the Examples 1 to 3 had high transmittance and low reflectivity such that they do not critically reduce vision through the glass pane. In addition, their sheet resistance was suitable for obtaining a good heating effect with a voltage supply of approx. 230 V. The fact that this can be obtained with such thin conductive ITO layers 4 was unexpected and surprising for the person skilled in the art.

### LIST OF REFERENCE CHARACTERS

(1) substrate
(2) heatable coating
(3) optical matching layer
(4) electrically conductive layer
(5) barrier layer for regulating oxygen diffusion
(6) antireflection layer
(7) blocking layer against alkali diffusion

1. Pane having a heatable coating, comprising a substrate and a heatable coating on an exposed surface of the substrate, which heatable coating at least comprises
an electrically conductive layer, which contains a transparent, electrically conductive oxide and has a thickness of 1 nm to 40 nm, and
above the electrically conductive layer, a dielectric barrier layer for regulating oxygen diffusion, which dielectric barrier layer contains a metal, a nitride, or a carbide and has a thickness of 1 nm to 20 nm,
wherein the pane has transmittance in the visible spectral range of at least 70% and the coating has sheet resistance of 50 ohms/square to 200 ohms/square.

2. The pane according to claim 1, wherein the electrically conductive layer contains indium tin oxide.

3. The pane according to claim 1, wherein the electrically conductive layer has a thickness of 10 nm to 35 nm.

4. The pane according to claim 1, wherein the barrier layer contains silicon nitride or silicon carbide.

5. The pane according to claim 1, wherein the barrier layer has a thickness of 2 nm to 10 nm.

6. The pane according to claim 1, wherein the coating contains an optical matching layer below the electrically conductive layer and an antireflection layer above the barrier layer and wherein the optical matching layer and the antireflection layer have a refractive index of 1.3 to 1.8.

7. The pane according to claim 6, wherein the optical matching layer and/or the antireflection layer contains at least one oxide.

8. The pane according to claim 6, wherein the optical matching layer has a thickness of 5 nm to 50 nm, and wherein the antireflection layer has a thickness of 10 nm to 100 nm.

9. The pane according to claim 1, wherein the coating contains, below the electrically conductive layer, a blocking layer against alkali diffusion.

10. The pane according to claim 9, wherein the blocking layer contains silicon nitride.

11. The pane according to claim 9, wherein the blocking layer has a thickness of 5 nm to 50 nm.

12. The pane according to claim 1, wherein the substrate is a thermally prestressed glass pane.

13. Method for producing a pane having a heatable coating, comprising
(a) successively applying on a surface of a substrate at least
an electrically conductive layer that contains a transparent, electrically conductive oxide and has a thickness of 1 nm to 40 nm, and
a dielectric barrier layer for regulating oxygen diffusion that contains at least a metal, a nitride, or a carbide;
(b) subjecting the substrate with the coating to a temperature treatment at at least 100° C., after which the pane has transmittance in the visible spectral range of at least 70% and the coating has sheet resistance of 50 ohms/square to 200 ohms/square.

14. The method according to claim 13, wherein the temperature treatment is done in the context of thermal prestressing.

15. A method comprising utilizing a pane according to claim 1 with an operating voltage of 40 V to 250 V as a refrigerator door, oven door, partition, bathroom mirror, or window.

16. The pane according to claim 4, wherein the barrier layer contains silicon nitride.

17. The pane according to claim 7, wherein the at least one oxide is a silicon oxide that is optionally aluminum-doped, zirconium-doped, or boron-doped.

18. The pane according to claim 8, wherein the optical matching layer has a thickness of 5 nm to 30 nm, and wherein the antireflection layer has a thickness of 15 nm to 50 nm.

19. The pane according to claim 10, wherein the blocking layer contains silicon nitride that is optionally aluminum-doped, zirconium-doped, or boron-doped.

20. The pane according to claim 11, wherein the blocking layer has a thickness of 5 nm to 30 nm.
